(19) United States
(12) Patent Application Publication
(10) Pub. No.: US 2009/0123710 A1
(43) Pub. Date: May 14, 2009

(54) FIRE-RESISTANT PANEL DOOR

(75) Inventor: John O. Dunkin, Grants Pass, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: ROGUE VALLEY DOOR, Grants Pass, OR (US)

(21) Appl. No.: 11/937,288

(22) Filed: Nov. 8, 2007

(51) Int. Cl. B29C 65/00; B32B 23/02

(52) U.S. Cl. 428/192; 156/250; 156/304.1

(57) ABSTRACT

Systems, methods, and apparatuses relating to a fire-resistant panel door are disclosed herein. The fire-resistant panel door may have two skins constructed of edge adhered components with relief patterns routed along edges of at least some of the components. Other embodiments may be described and claimed.

### TECHNICAL FIELD

Embodiments of the present invention relate to the field of fire-resistant doors and, in particular, to fire-resistant panel doors.

### BACKGROUND

Fire doors are a type of passive fire protection used to prevent or hinder the spread of a fire within a building. Typical fire doors are constructed entirely of fire-resistant material such as steel, gypsum, vermiculite, etc.

Traditional panel doors, i.e., doors made from a stile and rail assembly, lack a solid core that forms the substrate of a fire door. Prior art efforts to make these types of panel doors fire resistant have resulted in expensive and laborious construction processes.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 is a flowchart illustrating a manufacture of a fire-resistant door in accordance with various embodiments of the present invention;

FIG. 2 is routing/extraction system in accordance with various embodiments of the present invention;

FIG. 3 illustrates components extracted from one or more blanks in accordance with various embodiments of the present invention;

FIG. 4 is a front view of a skin of a fire-resistant door in accordance with various embodiments of the present invention;

FIG. 5 is a side view of layers of a fire-resistant door being face adhered to one another in accordance with various embodiments of the present invention;

FIG. 6 is a cross-section view of relief pattern in accordance with various embodiments of the present invention;

FIG. 7 is a front view of the fire resistant door in accordance with various embodiments of the present invention;

FIG. 8 is a cross-section view of a shaped edge of the door in accordance with various embodiments of the present invention; and

FIG. 9 illustrates a system capable of implementing a computing device in accordance with various embodiments of the present invention.

### DETAILED DESCRIPTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrases “A/B” and “A and/or B” mean (A), (B), or (A and B). For the purposes of the present invention, the phrase “A, B, and/or C” means (A), (B), (C), (A and B), (A and C), (B and C), or (A, B, and C). For the purposes of the present invention, the phrase “(A)B” means (B) or (A and B), that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Embodiments of the present invention teach a fire-resistant panel door and systems and methods for making the same. As used herein, a fire-resistant door may mean a door that is qualified to withstand a standard fire endurance test for a specified period of time. The specified period of time may provide the fire rating for a particular type of door. Embodiments of the present invention provide fire-resistant doors with fire ratings including, but not limited to, twenty minutes, thirty minutes, forty-five minutes, sixty minutes, or ninety minutes. In some embodiments, the fire rating may be compatible with American Society of Testing and Materials (ASTM) E119-07a “Standard Test Methods for Fire Tests of Building Construction and Materials” including any amendments, updates, or revisions. Other embodiments may include other types of fire ratings and/or standardization processes.

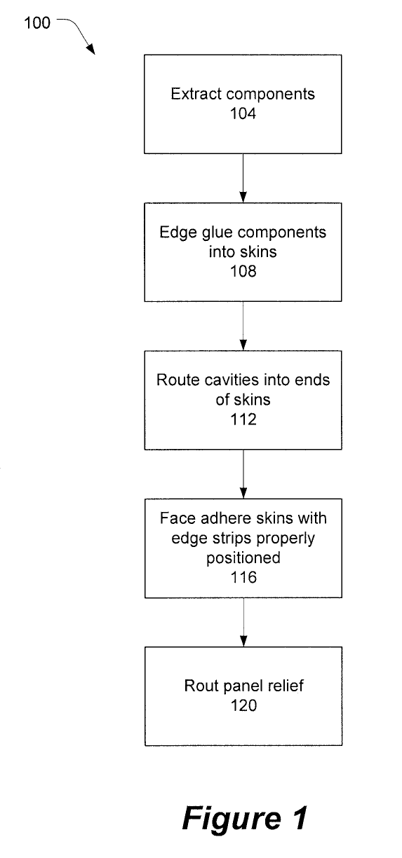

FIG. 1 is a flowchart 100 illustrating manufacture of a fire-resistant door in accordance with various embodiments. At block 104, components of first and second skins may be extracted from one or more blanks. The blanks may be made of any of a variety of wood species, e.g., alder, ash, birch, cherry, fir, hickory, pine, mahogany, maple, oak, poplar, walnut, or white oak. In other embodiments, the blanks may be made of an engineered wood product, e.g., a medium density fiberboard (MDF).

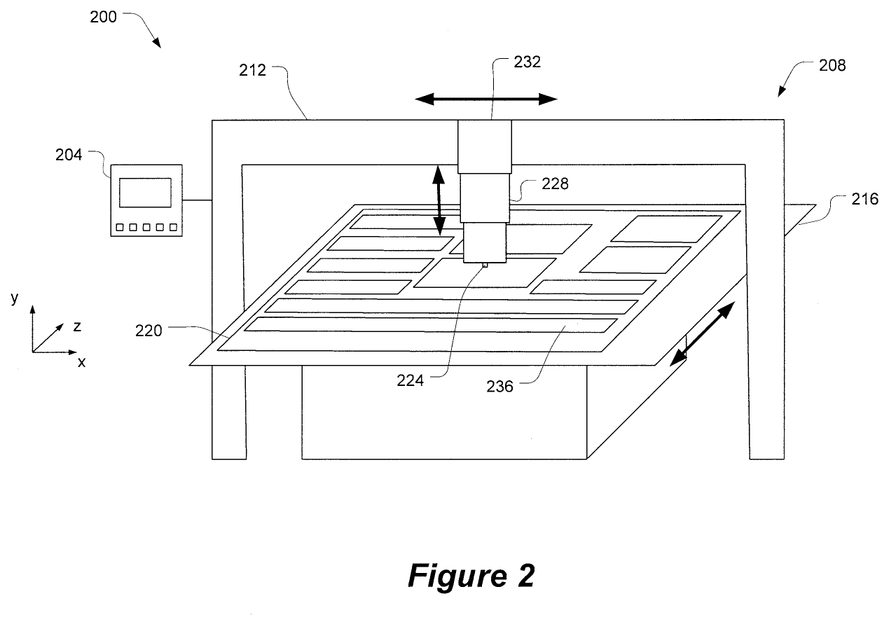

The extraction of the components from the blanks may be done by a routing/extraction system (hereinafter “system”) 200 as shown in FIG. 2 in accordance with an embodiment of the present invention. The system 200 may include a computing device 204 to control a cutting device 208. In some embodiments, the cutting device 208 may be a programmable cutting device controlled by programming instructions. For example, in some embodiments the computing device 204 may implement a computer-aided manufacturing (CAM) program to generate a cut map, with or without user input, as a series of programming instructions for implementation. In these embodiments, the programming instructions may then be transmitted to the cutting device 208, which, in this instance, may be a device capable of processing said instructions, such as, but not limited to a computer-numerical control (CNC) router.

The cutting device 208 may have a bridge 212 to support various elements and a table 216 to receive a blank 220.

The cutting device 208 may include a cutting tool 224 on a telescopic extension 228 that is coupled to the bridge 212 by a carriage 232. The cutting tool 224 may be provided motion in the y-direction by the telescopic extension 228; motion in the x-direction by the carriage 232 traveling along the bridge 212; and relative motion in the z-direction by movement of the table 216. In other embodiments, other component extraction systems may be used.

The computing device 204 may control the cutting device 208 to extract a number of components 236 from the blank 220. In various embodiments, the components 236 may be extracted from a number of blanks.

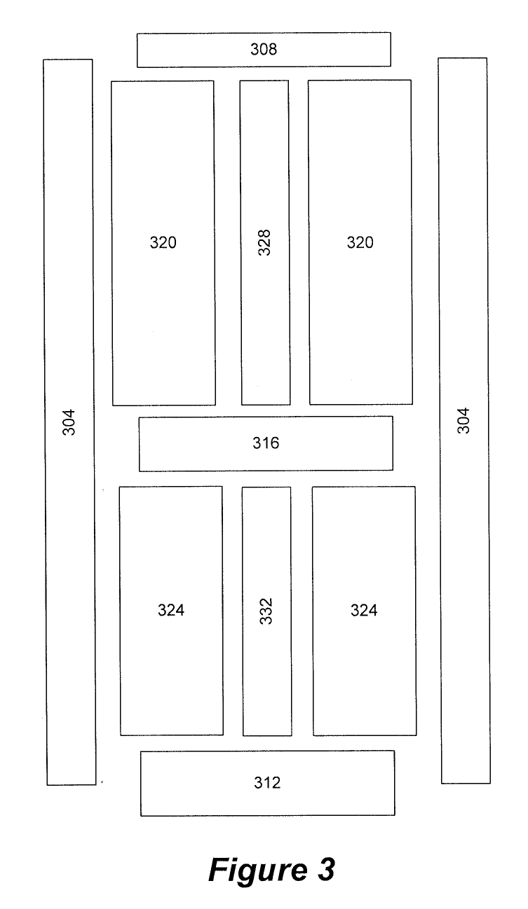

FIG. 3 illustrates the components 236 extracted from one or more blanks in accordance with various embodiments. More specifically, the components 236 may include two stiles 304, a top rail 308, a bottom rail 312, an intern 316, two top panels 320, two bottom panels 324, a top mullion 328, and a bottom mullion 332. The components 236, being extracted from the same or similar blanks, may each have the same thickness (dimension into the page of FIG. 3). However, the length (vertical dimension of FIG. 3) and width (horizontal dimension of FIG. 3) may vary. Also, in various embodiments, other numbers, types, and sizes of the various components may be changed depending on the specific design of a given embodiment.

At block 108, the components, including components 236, may be aligned and edge adhered to one another to form the skins.

As used herein, edge adhering may mean any form of adhering one component to another component using any type of adhesive, e.g., a natural and/or synthetic glue, along corresponding edges of the components.

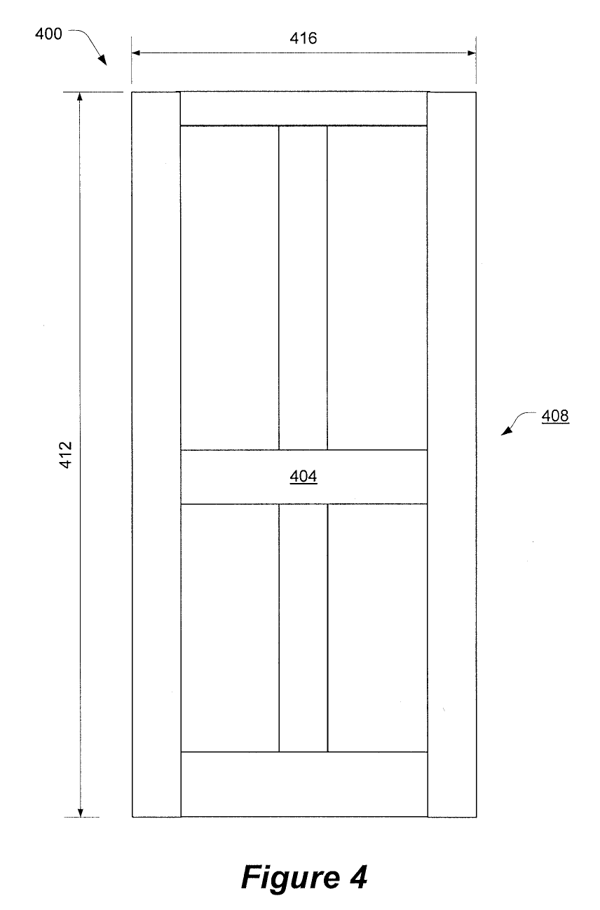

Edge adhering the components 236 may involve an application of an adhesive to appropriate edges, compressing the components 236 together, e.g., by clamping, and allowing the components 236 to set for a period of time. The resulting skin 400 is shown in FIG. 4 in accordance with an embodiment of the present invention. The skin 400 may have a front face 404 and a back face 408. The faces of the skin 400 may have a continuous surface over the length 412 and width 416 of the skin 400.

In some embodiments, the faces 404 and/or 408 may be sanded to achieve a desired thickness of the skin 400 after formation.

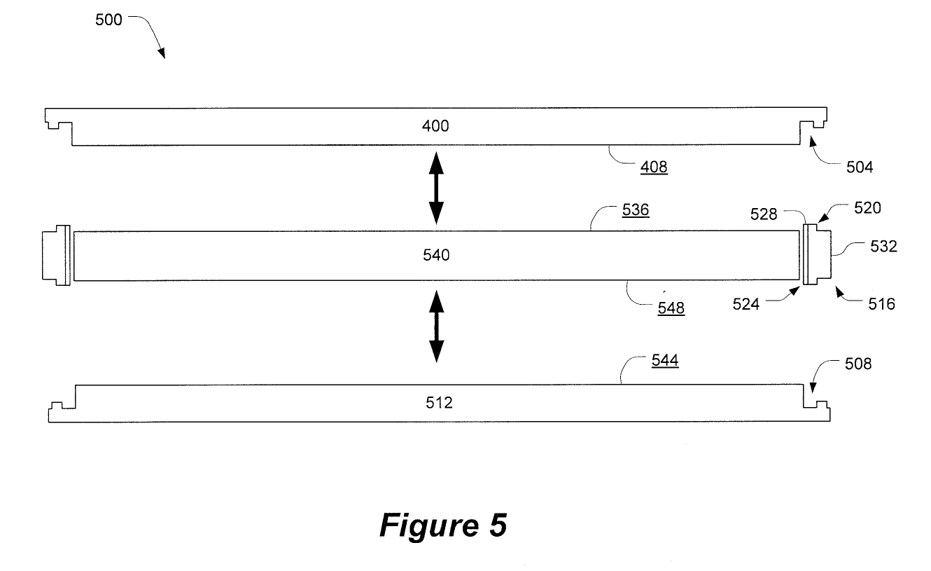

Referring now to FIG. 5, cavities, e.g., cavities 504 and 508, may be routed into ends of skin 400 and skin 512, which may be substantially similar to skin 400, to form an edge profile at block 112. In some embodiments, cavities may be routed into both stiles and the top rail.

The edge profile may be configured to complement edge strips, e.g., edge strip 516. The edge strip 516 may include a first extension 520 to be inserted in the cavity 504 and a second extension 524 to be inserted in the cavity 508. The extensions may be symmetrically disposed on opposing sides of a body of the edge strip 516. Both of the extensions may extend from the body in a direction of an extension plane that is orthogonal to an axis plane of the door 500. The axis plane of the door 500 may be a two-dimensional plane formed by the length and width dimensions of the door 500.

The edge strips may allow for hardware, e.g., bolts, lockset, hinges, to be attached to the edge of the door. Edge strip 516 may have a relatively thin layer of intumescent material 528 attached to wood 532. The wood 532 may be the same species/type of wood used as in the skins or it may be different. In some embodiments the intumescent material 528 may have a thickness of about ⅛ of an inch.

Following formation of the edge profiles, the edge strips may be aligned with corresponding cavities and the layers may be face adhered to one another at block 116 to form an assembled door 500. In particular, the face 408 of skin 400 may be face adhered to a face 536 of a fire-resistant core 540 and a face 544 of skin 512 may be face adhered to a face 548 of the fire-resistant core 540, as shown. In some embodiments, the face 408 may be coextensive with the face 536 and face 548 may be coextensive with face 544. As used herein, a face may be coextensive with another face when both faces have continuous surfaces and similar length and width dimensions.

As used herein, face adhering may mean any form of adhering one layer to another layer using adhesive spread along corresponding faces of the layers.

In this embodiment, the layers may have the adhesive spread on one or more faces by being run through an adhesive spreading machine. After adhesive has been spread on the appropriate faces of the various layers, the layers may be compressed together, e.g., by being put on a press, and allowed to set for a period of time.

In various embodiments, the fire-resistant core 540 may be constructed of fire-resistant materials including, but not limited to, steel, gypsum, vermiculate, etc.

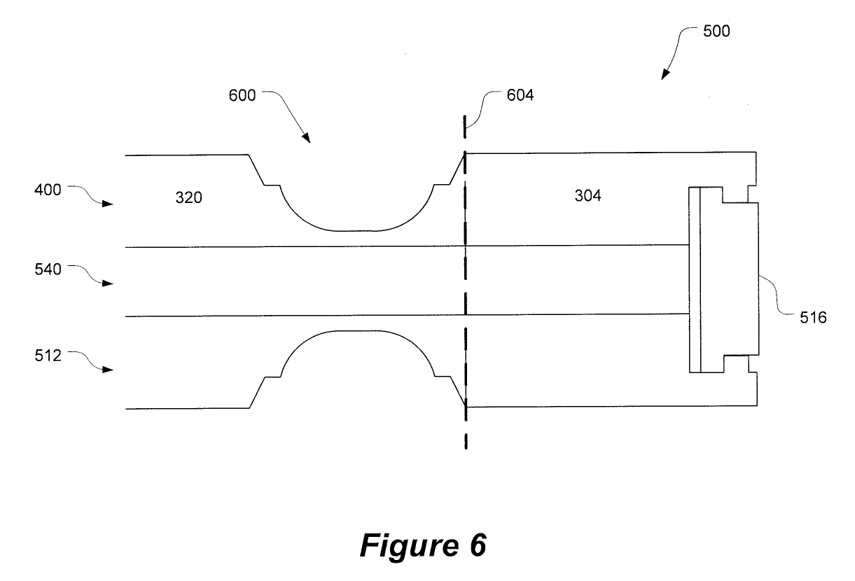

At block 120, the assembled door 500 may be brought back to the cutting device 208 for routing relief around perimeter edges of one or more of the components 236, e.g., the panels 320 and/or 324. FIG. 6 illustrates a relief pattern 600 in accordance with an embodiment of the present invention. In various embodiments any type of relief pattern may be used.

The computing device 204 may still have the cut map used to extract the components 236 at block 104. Accordingly, the computing device 204 may be capable of controlling the cutting device 208 in a manner such that the relief pattern 600 is carved into the panel 320 precisely at the joint of the panel 320 and stile 304.

The positioning and design of the edge strip 516 may facilitate a consistent alignment of the skins, which may, in turn, facilitate this precise routing of the relief patterns around the perimeters of the panels on both sides of the door 500. The consistent alignment of the skins may be evidenced in FIG. 6 by the dotted line 604 showing the alignment of the stile-panel joint of the skin 400 and the stile-panel joint of the skin 512.

A similar relief pattern may be routed into the perimeter of the remaining panels, e.g., the other top panel 320, the two bottom panels 324, and the panels on the skin 512.

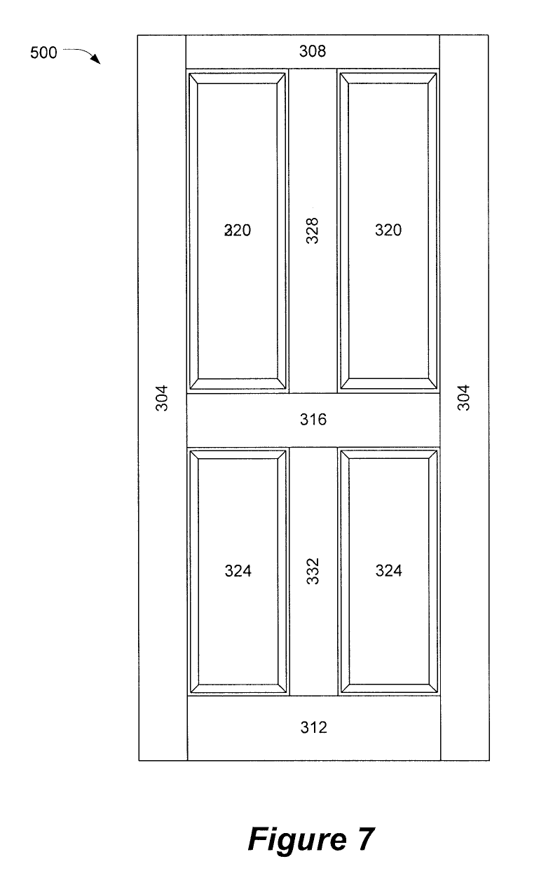

FIG. 7 is a front view of the door 500 with the relief routed around perimeter edges of the panels 320 and 324 in accordance with various embodiments.

In some embodiments, bead strips may be attached within the relief pattern, e.g., at the joint between the panels and adjoining components.

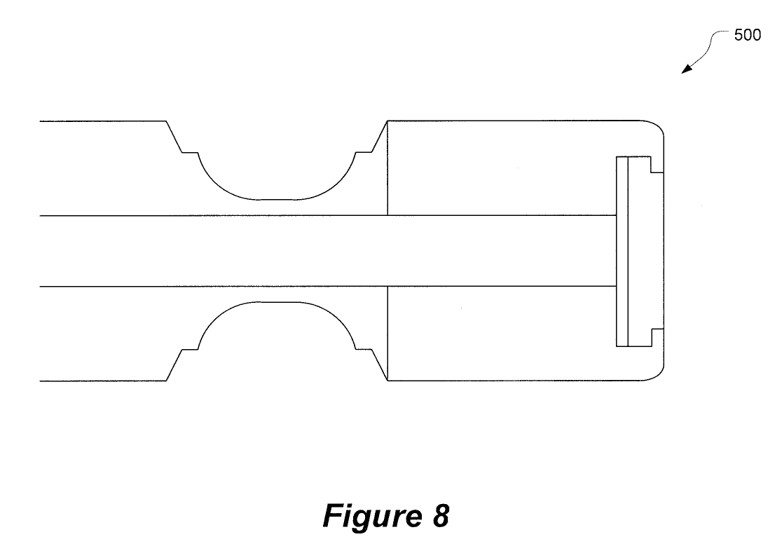

In various embodiments, the edge of the door may be shaped as shown in FIG. 8 and the manufacture may be substantially complete.

It may be noted that the order of operations depicted by the flowchart 100 may be different in different embodiments.

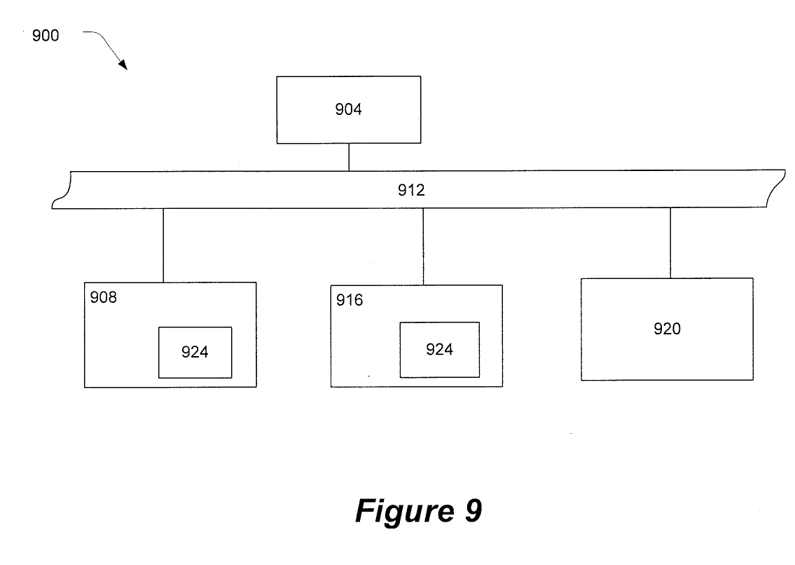

FIG. 9 illustrates a system 900 capable of implementing the computing device 204 in accordance with various embodiments. As illustrated, for the embodiments, system 900 includes processor 904, memory 908, and bus 912, coupled to each other as shown. Additionally, computing device 900 includes storage 916, and communication interfaces 920, e.g., an input/output port, coupled to each other, and the earlier described elements as shown.

Memory 908 and storage 916 may include, in particular, temporal and persistent copies of cutting logic 924, respectively. The cutting logic 924 may include instructions that when executed by the processor 904 results in generation of programming instructions and provision of the programming instructions to a cutting device, e.g., cutting device 208, that controls extraction and/or routing functions as described herein.

In various embodiments, the memory 908 may include random access memory (RAM), dynamic RAM (DRAM), static RAM (SRAM), synchronous DRAM (SDRAM), dual-data rate RAM (DDRRAM), etc.

In various embodiments, the processor 904 may include one or more single-core processors, multiple-core processors, controllers, application-specific integrated circuits (ASICs), etc.

In various embodiments, storage 916 may be a machine-accessible medium that includes integrated and/or peripheral storage devices, such as, but not limited to, disks and associated drives (e.g., magnetic, optical), universal serial bus (USB) storage devices and associated ports, flash memory, read-only memory (ROM), nonvolatile semiconductor devices, etc.

In various embodiments, storage 916 may be a storage resource physically part of the system 900 or it may be accessible by, but not necessarily a part of, the system 900. For example, the storage 916 may be accessed by the system 900 over a network via the communication interfaces 920.

In various embodiments, system 900 may have more or less components, and/or different architectures.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments illustrated and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A door comprising:
a first skin having a plurality of components edge adhered to one another and a face including a continuous surface;
a fire-resistant core having a first face attached to the face of the first skin and a second face; and
a second skin having a plurality of components edge adhered to one another and a face including a continuous surface attached to the second face of the fire-resistant core.

2. The door of claim 1, wherein the door has a fire rating of twenty minutes or greater.

3. The door of claim 1, wherein the first and second skins are comprised of a single wood species.

4. The door of claim 1, further comprising an edge strip, including an intumescent material, disposed at an edge of the door, the edge strip having a first extension extending into a cavity of the first skin and a second extension extending into a cavity of the second skin.

5. The door of claim 4, wherein the edge strip includes a body and the first extension is on a first side of the body and the second extension is on a second side of the body, the first side and the second side being opposite sides.

6. The door of claim 5, wherein the first extension and the second extension extend from the body in a direction of an extension plane that is orthogonal to an axis plane of the door.

7. The door of claim 1, wherein the first face of the fire-resistant core is coextensive with the face of the first skin and the second face of the fire-resistant core is coextensive with the face of the second skin.

8. The door of claim 1, wherein the plurality of components of the first skin include one or more panels, each of the one or more panels having a relief pattern routed around its perimeter.

9. A method comprising:
extracting a first plurality of components and a second plurality of components from one or more blanks;
edge adhering the first plurality of components to form a first skin having a face with a continuous surface;
edge adhering the second plurality of components to form a second skin having a face with a continuous surface;
face adhering the face of the first skin to a first face of a fire-resistant core; and
face adhering the face of the second skin to a second face of the fire-resistant core.

10. The method of claim 9, further comprising:
routing a cavity into a first end of the first skin;
routing a cavity into a first end of the second skin; and
adhering an edge strip to the first and second skins such that a first extension of an edge strip is positioned within the cavity of the first skin and a second extension of the edge strip is positioned within the cavity of the second skin.

11. The method of claim 10, wherein the first extension of the edge strip is positioned within the cavity of the first skin substantially simultaneous with said face adhering the face of the first skin to the first face of the fire-resistant core.

12. The method of claim 11, wherein the second extension of the edge strip is positioned within the cavity of the second skin substantially simultaneous with said face adhering the face of the second skin to the second face of the fire-resistant core.

13. The method of claim 10, wherein the first plurality of components includes one or more panels and the method further comprises:
routing, after said adhering of the edge strip to the first and second skins, a relief around a perimeter of each of the one or more panels.

14. The method of claim 13, wherein said extracting and routing are done by a computer numerical controlled router.

15. A door comprising:
a first skin having a plurality of edge adhered components and a face, at least one of the plurality of edge adhered components having a relief routed along a perimeter edge;
a fire-resistant core having a first face attached to, and coextensive with, the face of the first skin and a second face; and
a second skin having a plurality of edge adhered components and a face attached to, and coextensive with, the second face of the fire-resistant core.

16. The door of claim 15, further comprising an edge strip, including an intumescent material, disposed at an edge of the door, the edge strip having a first extension extending into a cavity of the first skin and a second extension extending into a cavity of the second skin.

17. The door of claim 15, wherein the door has a fire rating of twenty minutes or greater.

18. The door of claim 15, wherein the first and second skins are comprised of a single wood species.

19. A machine-accessible medium having associated instructions that, when executed, results in a machine:
controlling a cutting device to extract a plurality of components including one or more panels from one or more blanks;
controlling the cutting device to rout a relief pattern around a perimeter of each of the one or more panels, wherein prior to said controlling the cutting device to route the relief pattern, the one or more panels are edge adhered to one another to form a face.

20. The machine-accessible medium of claim 19, wherein the associated instructions, when executed, further results in the machine:
controlling the cutting device to rout the relief pattern based at least in part on said controlling of the cutting device to extract the plurality of components.
